(19) United States
(12) Patent Application Publication
(10) Pub. No.: US 2024/0112126 A1
(43) Pub. Date: Apr. 4, 2024

(54) SYSTEM AND METHOD FOR PARCEL DELIVERY

(71) Applicant: 6518729 CANADA INC., Saint-Laurent (CA)

(72) Inventors: Jim McKAY, Brampton (CA); Todd MORRISON, Brampton (CA)

(21) Appl. No.: 18/478,594

(22) Filed: Sep. 29, 2023

Related U.S. Application Data
(60) Provisional application No. 63/377,804, filed on Sep. 30, 2022.

(51) Int. Cl. G06Q 10/0833

(52) U.S. Cl. CPC G06Q 10/0833

(57) ABSTRACT

A method and system for last-meter parcel delivery in multi-unit dwellings are provided. The method includes receiving, at an agent coordinating back-end, parcel delivery information of a parcel to be delivered to a recipient by a courier service, determining one or more agents capable of receiving parcels for last-meter delivery to the recipient, and transmitting a delivery notification based on the parcel delivery information to one or more agent devices associated with the one or more agents. The method also includes receiving confirmation from an agent device that the delivery notification is accepted, transmitting, to the courier service, agent information for re-routing the parcel to the agent, receiving a confirmation from the agent device that the parcel is received by the agent, and receiving a confirmation from the agent device that last-meter delivery of the parcel to the recipient is performed.

### CROSS-REFERENCE TO RELATED APPLICATIONS

This application claims the benefit of, and priority to, U.S. provisional application No. 63/377,804, filed Sep. 30, 2022, entitled SYSTEM AND METHOD FOR PARCEL DELIVERY, the contents of which is hereby incorporated by reference in its entirety.

### TECHNICAL FIELD

The technical field generally relates to transportation and delivery of parcels, and more particularly to systems and methods for facilitating last meter delivery of parcels, such as in multi-unit dwellings.

### BACKGROUND

Parcel transportation and delivery has become a staple of modern life. Online shopping has rendered parcel delivery to customers ubiquitous and an almost necessary offer from goods providers such as online shops, online grocery stores, and the like. Generally, after having picked up and processed a given parcel, a courier will attempt delivery of the parcel to the recipient's designated address. While the process of delivering the parcel may be straightforward when the address corresponds to a house, delivering parcels to a multi-unit dwelling, such as apartments and condominiums, is a more complicated process, given the usual security/privacy measures restricting access to the multi-unit dwelling. For example, a locked door at the entrance of the multi-unit dwelling may prevent the courier from entering the building and accessing the door of an individual unit to which the parcel must be delivered. In such cases, the courier must contact the recipient to be granted access to the building. Alternatively, the parcel may be left in a designated safe area within a common area of the building, or with a concierge, and the recipient is thereafter responsible for retrieving the parcel. Similar challenges can be faced when delivering goods at other destinations, such as office buildings, gated communities, etc.

As can be appreciated, contacting individual recipients to complete multiple deliveries can be time consuming. It may also be undesirable to give couriers access to a secured area of the building. Moreover, leaving parcels unattended can generate security concerns. Therefore, there is a need for an improved delivery system and method solving at least some of these problems.

### SUMMARY

Some aspects of the present disclosure include:
1. A method for last-meter parcel delivery comprising:
   receiving, at an agent coordinating back-end, parcel delivery information of a parcel to be delivered to a recipient by a courier service;
   determining, by the agent coordinating back-end, one or more agents capable of receiving parcels for last-meter delivery to the recipient;
   transmitting, by the coordinating back-end, a delivery notification based on the parcel delivery information to one or more agent devices associated with the one or more agents;
   receiving, by the coordinating back-end, confirmation from an agent device that the delivery notification is accepted by an agent associated with the agent device;
   transmitting to the courier service, by the coordinating back-end, agent information, for re-routing the parcel to the agent;
   receiving, by the agent coordinating back-end, a confirmation from the agent device that the parcel is received by the agent; and
   receiving, by the agent coordinating back-end, a confirmation from the agent device that last-meter delivery of the parcel to the recipient is performed.
2. The method of aspect 1, further comprising steps of:
   scanning, with the agent device, parcel information associated with the parcel upon at least one of receiving said parcel by the agent and performing the last-meter delivery of the parcel;
   receiving, at the coordinating back-end, status updates from the agent device based on the scanning of the parcel information, for tracking the parcel; and
   forwarding, by the coordinating back-end, the status updates to the courier service.
3. The method of aspect 1, wherein:
   the recipient is associated with a destination address,
   agents are each associated with a range of addresses, and
   the step of determining the one or more agents comprises comparing the destination address with the range of addresses of each agent and identifying the one or more agents having a respective range of addresses matching the destination address.
4. The method of aspect 3, wherein a given range of addresses corresponds to addresses located within a multi-unit dwelling, and wherein determining the one or more agents further comprises verifying that the one or more agents have physical access to the multi-unit dwelling of the destination address.
5. The method of aspect 4, wherein the multi-unit dwelling is provided with a management software, and wherein the steps further comprise:
   transmitting, to the management software, a confirmation from the agent device that the parcel is received at the multi-unit dwelling by the agent.
6. The method of aspect 3, wherein only one agent is associated with a given range of addresses, and wherein the step of transmitting the delivery notification comprises transmitting the delivery notification to an agent device associated with the one agent.
7. The method of aspect 3, further comprising steps of:
   identifying, by the agent coordinating back-end, a plurality of parcel deliveries for which recipients are located within a given range of addresses; and
   grouping the plurality of parcel deliveries into a job delivery notification,
   wherein the job delivery notification is transmitted to the one or more agent devices.
8. The method of aspect 1, further comprising a step of:
   transmitting, to a recipient device, an update notification upon the agent receiving the parcel, the update notification indicative that the parcel is ready for pick-up by the recipient.
9. The method of aspect 1, further comprising a step of:
   transmitting, to a recipient device, an update notification upon the agent receiving the parcel, the update notification indicative that the parcel is out for delivery at a destination address associated with the recipient.
10. The method of aspect 1, further comprising, upon unsuccessful last-meter delivery of the parcel to the recipient:
   transmitting a request for parcel pick-up to the courier service, the request including a pick-up address; and
   receiving, by the agent coordinating back-end, a confirmation that the parcel is picked up by the courier service.
11. A system for last-meter parcel delivery of a parcel to be delivered by a courier service to a recipient, the system comprising:
   an agent device associated with an agent and comprising a user interface adapted to interact with the agent, and
   an agent coordinating server adapted to communicate with the agent device and courier server associated with the courier service, the agent coordinating server being further adapted to:
      receive, from the courier server, parcel delivery information associated with the parcel;
      transmit a delivery notification based on the parcel delivery information to the agent device upon determining that the agent is capable of receiving parcels for last-meter delivery to the recipient;
      receive confirmation from the agent device that the delivery notification is accepted;
      transmit agent information to the courier server for re-routing the parcel to the agent;
      receive a confirmation from the agent device that the parcel is received by the agent; and
      receive a confirmation from the agent device that last-meter delivery of the parcel to the recipient is performed.
12. The system of aspect 11, wherein the user interface is further adapted to enable scanning parcel information associated with the parcel upon at least one of receiving said parcel by the agent and performing the last-meter delivery of the parcel, and wherein the agent coordinating server is further adapted to:
   receive status updates from the agent device based on the scanning of the parcel information, for tracking the parcel; and
   forward the status updates to the courier server.
13. The system of aspect 11, further comprising a plurality of agent devices associated with a plurality of agents, each of the plurality of agents associated with a range of addresses, wherein the agent coordinating server is further adapted to transmit the delivery notification to one or more agent devices associated with one or more agents having a range of addresses matching a destination address associated with the recipient.
14. The system of aspect 13, wherein a given range of addresses corresponds to addresses located within a multi-unit dwelling, and wherein the delivery notification is transmitted to the one or more agents having physical access to the multi-unit dwelling.
15. The method of aspect 14, wherein the multi-unit dwelling is provided with a management software, and wherein the system is further adapted to: transmit, to the management software, a confirmation that the parcel is received at the multi-unit dwelling by the agent.
16. The system of aspect 13, wherein the agent coordinating server is further adapted to:
   identify a plurality of parcel deliveries for which recipients are located within a given range of addresses; and
   group the plurality of parcel deliveries into a job delivery notification, the job delivery notification being transmitted as the delivery notification to the one or more agent devices.
17. The system of aspect 11, wherein the agent coordinating server is further adapted to:
   transmit, to a recipient device associated with a recipient of the parcel, an update notification upon the agent receiving the parcel, the update notification indicative that the parcel is ready for pick-up.
18. The system of aspect 11, wherein the agent coordinating server is further adapted to:
   transmit, to a recipient device associated with a recipient of the parcel, an update notification upon the agent receiving the parcel, the update notification indicative that the parcel is out for delivery to the recipient.
19. The system of aspect 11, wherein the user interface is further adapted to, upon unsuccessful last-meter delivery of the parcel, enable scheduling a request for parcel pick-up to the courier server, the request including a pick-up address, and wherein the agent coordinating server is further adapted to receive a confirmation that the parcel is picked up by the courier service.
20. A method for last-meter parcel delivery to multi-unit dwellings, comprising:
   scanning, by a courier, a parcel being loaded on a delivery vehicle for last-mile delivery to a recipient;
   determining, based on parcel information retrieved by scanning the parcel, one or more agents eligible to handle last-meter delivery of the parcel in a multi-unit dwelling associated with the recipient;
   transmitting a delivery notification to the one or more agents, the delivery notification indicating that the parcel is available for last-meter delivery by an agent;
   accepting responsibility for the last-meter delivery of the parcel by an agent of the one or more agents;
   rerouting the parcel delivery to the agent;
   delivering, by the courier, the parcel to the agent; and
   delivering, by the agent, the parcel to the recipient.

### BRIEF DESCRIPTION OF THE DRAWINGS

FIG. 1 is a schematic of a system for delivering parcels to multi-unit dwellings, according to an embodiment.

FIG. 2 is a flowchart of a method for delivering parcels to multi-unit dwellings, according to an embodiment.

FIG. 3 is a sequence diagram of the method shown in FIG. 2, where the parcel is handed off to an agent and thereafter delivered to the recipient.

FIG. 4 is a sequence diagram of the method shown in FIG. 2, where the parcel is handed off to an agent but where delivery cannot be completed.

FIG. 5 is a sequence diagram of the method shown in FIG. 2, where no agent is available to deliver a parcel.

FIGS. 6A through 14B are exemplary pages of a user interface of an agent device, according to an embodiment.

### DETAILED DESCRIPTION

It should be understood that the elements of the drawings are not necessarily depicted to scale, since emphasis is placed upon clearly illustrating the elements and structures of the present embodiments. In the following description, the same numerical references refer to similar elements. Furthermore, for the sake of simplicity and clarity, namely so as to not unduly burden the figures with several reference numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

In the following disclosure, the expression “last-mile” delivery refers to the last step in a parcel delivery process, whereby the parcel is transported by a courier from a delivery hub to its final destination. The expression “last-meter” delivery refers to a final portion of the journey between the delivery hub to the final destination, for example between the front door of a multi-unit dwelling and a door of an individual unit in the dwelling, between the front gate of a gated community and an individual residence in the gated community, between the front desk of an office building and a recipient within the office building, between when a parcel is dropped off by a courier at a pick up point and picked up by a recipient, etc.

The expression “agent” refers to an individual being capable and/or authorized to handle last-meter delivery of parcels to designated recipients. An agent can have access to a secured area where recipients are located, for example by having access to the interior of a multi-unit dwelling and being capable of delivering parcels to individual units therein, having access to the interior of an office building and being capable of delivering parcels to individual units therein, or having access to a neighborhood or gated community and capable of delivering parcels to individual residences, for example. An agent can be any person that has access to secured areas and/or has the required authorization or trust to handle parcel deliveries, such as a resident or a concierge of a residential building, a security officer of an office building or community, or an employee managing a parcel pick up point, for example.

The expression “courier service” refers to an organisation that provides services to deliver parcels (such as packages, letters, etc.) from a sender to a recipient. The courier service may or may not provide mechanisms to electronically track the status of parcels in their care. The term “courier” refers to an individual, such as an employee, tasked by the courier service to handle the delivery of a parcel to the recipient.

The expression “cooperating courier” or “cooperating courier service” refers to any courier service that interacts with the system described herein to authorize an agent to assist with the delivery of a parcel that is in their care. The cooperating couriers can have proprietary back-end systems for managing deliveries carried out by the couriers, including parcel delivery information and tracking statuses.

One or more systems described herein may be implemented in computer programs executing on processing devices, each comprising at least one processor, a data storage system (including volatile and non-volatile memory and/or storage elements), at least one input device, and at least one output device. The term “processing device” encompasses computers, servers and/or specialized electronic devices which receive, process and/or transmit data. “Processing devices” are generally part of “systems” and include processing means, such as microcontrollers and/or microprocessors, CPUs or are implemented on FPGAs, as examples only. For example, and without limitation, the processing device may be a programmable logic unit, a mainframe computer, server, and personal computer, cloud-based program or system, laptop, personal data assistance, cellular telephone, smartphone, wearable device, tablet device, video game console, or portable video game devices.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures, processes and methods described herein. In some embodiments, the system may be embedded within an operating system running on the programmable computer.

Furthermore, the system, processes and methods of the described embodiments are capable of being distributed in a computer program product comprising a computer readable medium that bears computer-usable instructions for one or more processors. The computer-usable instructions may also be in various forms including compiled and non-compiled code.

The processor(s) are used in combination with storage medium, also referred to as “memory” or “storage means”. Storage medium can store instructions, algorithms, rules and/or trading data to be processed. Storage medium encompasses volatile or non-volatile/persistent memory, such as registers, cache, RAM, flash memory, ROM, diskettes, compact disks, tapes, chips, as examples only. The type of memory is of course chosen according to the desired use, whether it should retain instructions, or temporarily store, retain or update data. Steps of the proposed methods and processes are implemented as software instructions and algorithms, stored in computer memory and executed by processors.

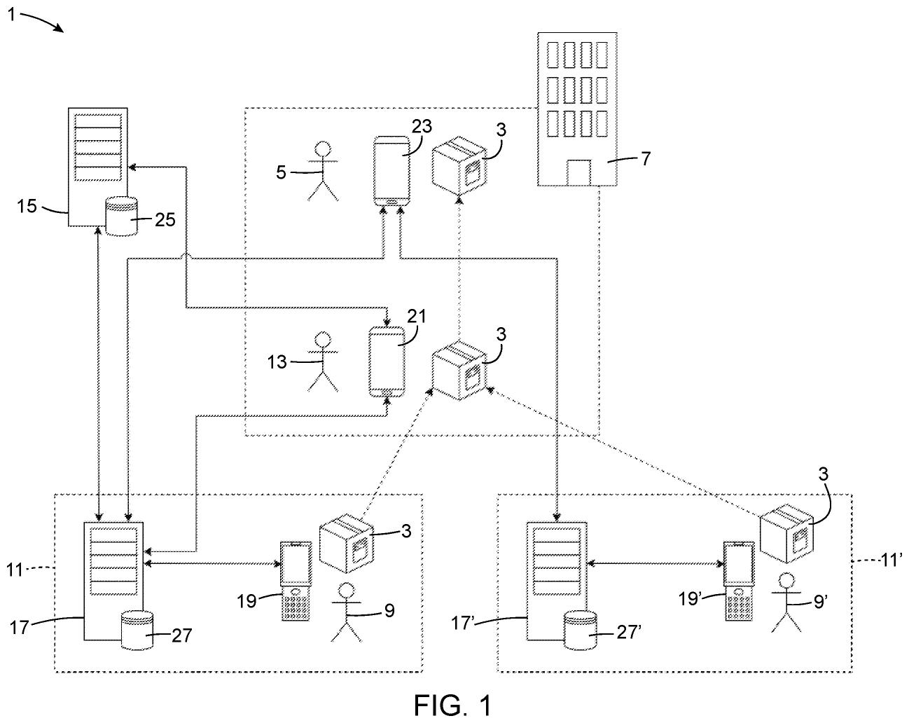

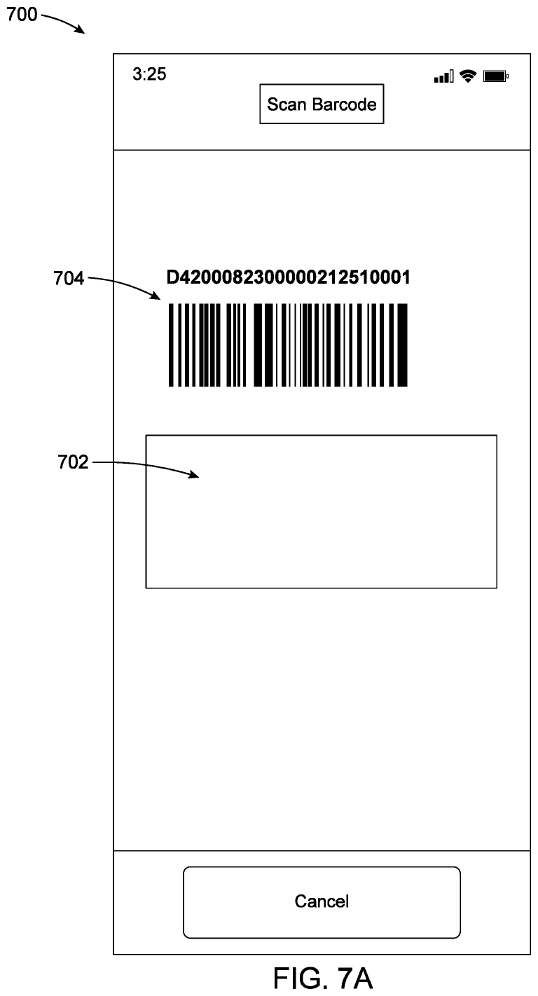

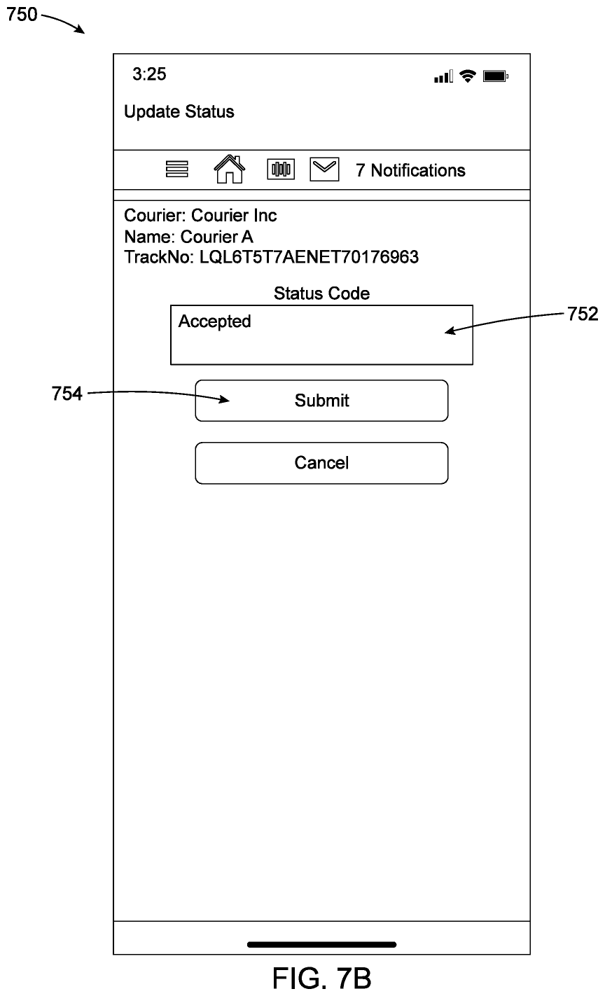

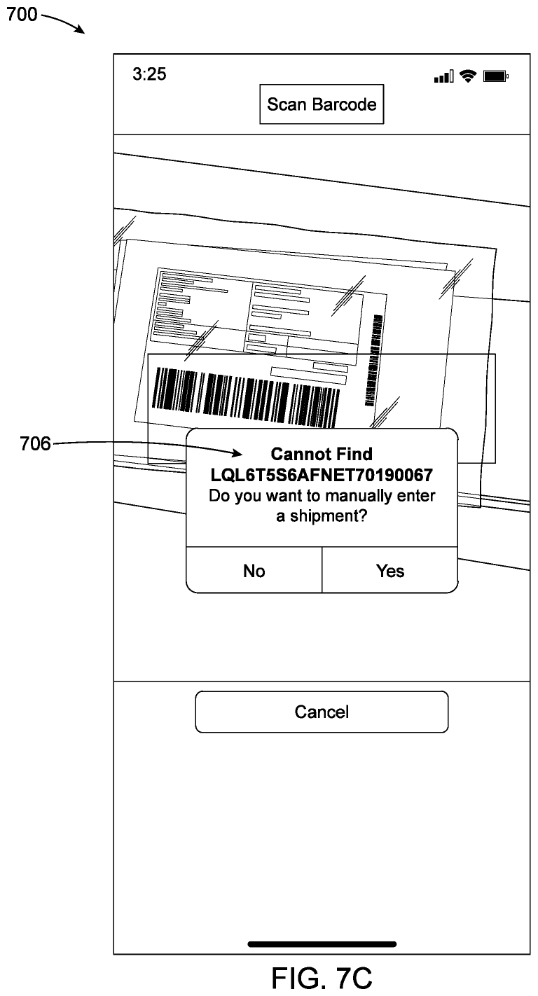

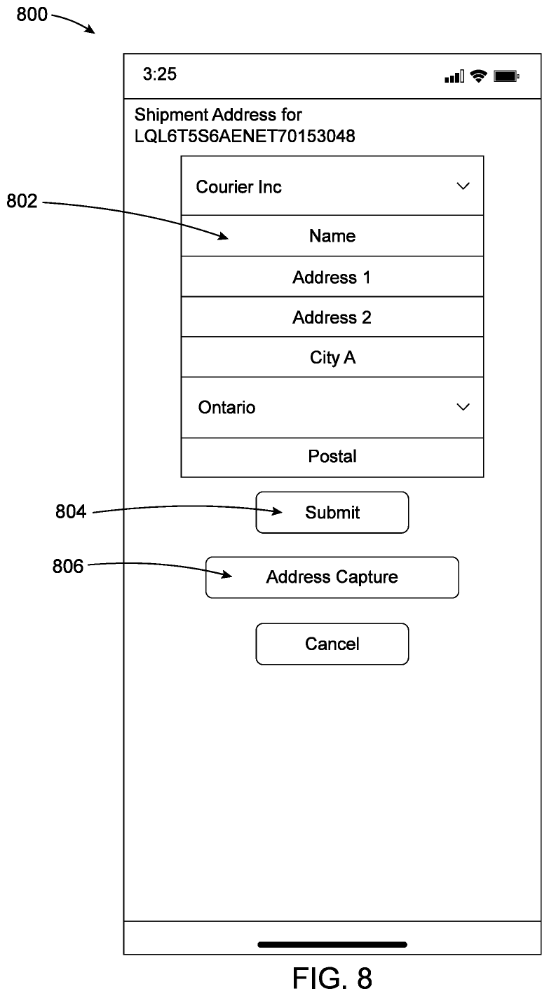

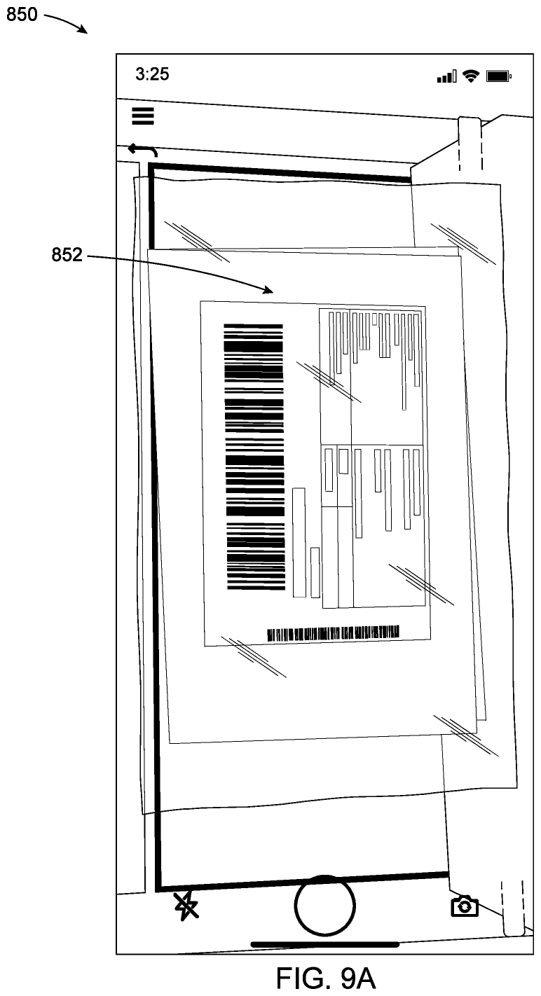

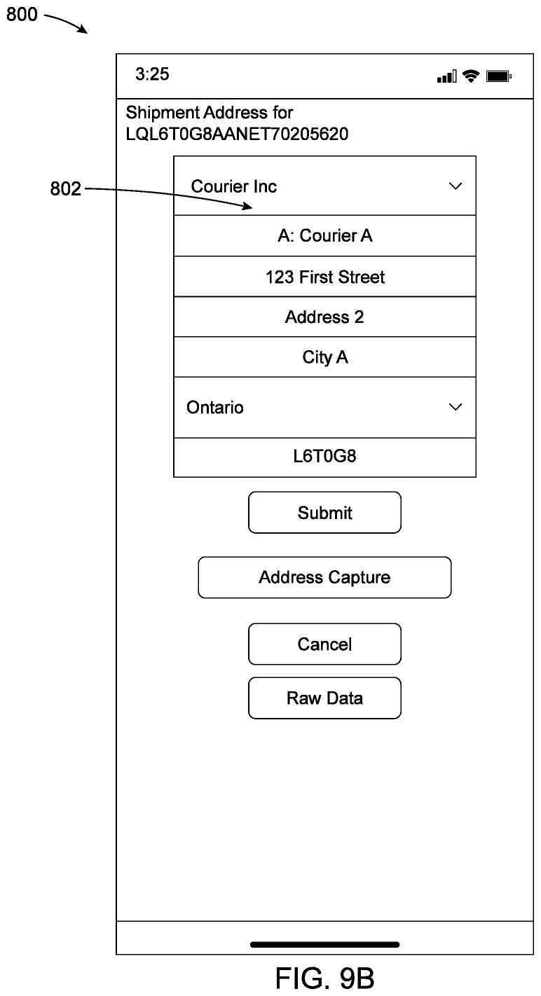

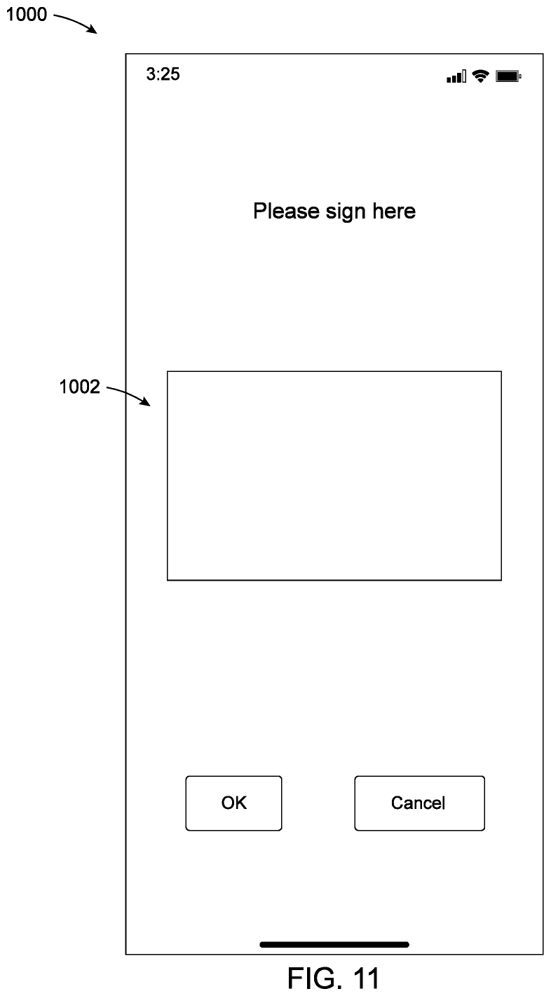

Referring to FIGS. 1 to 14B, a method and system for parcel delivery is disclosed. Generally, the method includes handing off parcels to be delivered to an agent to handle last-meter delivery of the parcel. Once the parcels are handed off to the agent, said agent will attempt to deliver the parcels to individual recipients. Delivery by the agent is facilitated via a user interface generated by a computer application of an agent device. The computer application enables an agent to accept parcel hand-offs from multiple couriers, and subsequently update statuses related to parcel delivery and/or return pickups.

In the following description, embodiments of the method and system will be described in connection with delivering parcels to multi-unit dwellings. In particular, one or more agents can be associated with a multi-unit dwelling in that they are designated as being capable and/or authorized to handle last meter delivery of parcels within that particular multi-unit dwelling. Parcels are handed off to the agent, and then the agent will attempt to deliver parcels to individual units in the dwelling corresponding to the original destination address associated with the parcel. Although this particular embodiment is described, it is appreciated that this is for exemplary purposes only, and that similar systems and methods can apply to deliver parcels in other settings, particularly any setting where an agent can be designated as being capable and/or authorized to handle last meter delivery of parcels to a plurality of potential recipients. For example, instead of a multi-unit dwelling, an agent can be designated to facilitate last meter delivery within an office building, within a neighborhood, within a gated community, and/or at a designated parcel pick up point.

The systems and methods disclosed herein can advantageously allow for overcoming delivery problems related to security and/or privacy associated with multi-unit dwellings or other private buildings/areas, since the last-meter delivery to the delivery address is performed by an individual having access to the dwelling/building/area and/or being otherwise authorized to deliver parcel within the dwelling/building/area.

The systems and methods described herein can be courier-agnostic in that agents can accept parcels from any courier service, further allowing to simplify deliveries from couriers within a multi-unit dwelling by removing the need for each courier to have access to the dwelling. In particular, the systems and methods allow for electronic parcel information to be received from cooperating couriers, such that the parcel hand-off, delivery by agents and tracking thereof can be simplified. The systems and methods also allow for parcel information to be entered manually by an agent, such that delivery and tracking of a parcel can be handled even if the parcel information was not received electronically (for example if the parcel is received by an agent from a non-cooperating courier). In this fashion, the systems and methods can allow for any parcel from any carrier to be accepted by agents for last-meter delivery in any building with which they are associated.

The systems and methods described herein can provide at least two operating modes. In a first operating mode, an agent accepts parcel hand-offs from a courier and is thereafter responsible for delivering the parcels to the recipients. The agent is alerted of available parcel hand-offs through hand-off notifications sent to their agent device when the parcels are “out-for-delivery”. In this first mode, the agent will usually not receive any parcel from couriers that are not cooperating couriers.

In a second mode, an agent is tasked with accepting all deliveries from any courier, whether hand-off notifications have been sent and accepted or not. That is, the agent may receive parcels from couriers outside of the cooperating couriers. In this second mode, the agent, for example a concierge of the multi-unit dwelling, may accept the parcel and manually input parcel information so that the last-meter delivery can be tracked and managed by the system. The agent can therefore accept deliveries from any courier, and deliver the parcels to the delivery address, even when the courier is not a cooperating courier.

Once the parcels are handed off to an agent, the agent can be thought of as the courier for the last leg of the journey to the recipient. In other words, the agent becomes responsible for delivering each parcel to the delivery address originally associated with the parcels.

While systems and methods are described with respect to one parcel, it should be understood that steps can be repeated for a plurality of parcels delivered by a cooperating courier.

With reference to FIG. 1, an exemplary system 1 for parcel delivery is shown according to an embodiment. In the illustrated embodiment, the system 1 is configured to facilitate delivery of a parcel 3 to a recipient 5 in a multi-unit dwelling 7. The parcel 3 is delivered to the multi-unit dwelling 7 by a courier 9 of a cooperating courier service 11 or a courier 9′ of a non-cooperating courier service 11′, and is handed off to an agent 13 in the dwelling 7 for final delivery to the individual unit in the multi-unit dwelling 7 where the recipient 5 resides. Broadly described, the system 1 involves a plurality of inter-communicating computing devices, including an agent coordinating back-end 15, courier service back-ends 17, 17′, courier mobile devices 19, 19′, agent computing device 21 and recipient computing device 23. The computing devices can communicate via any suitable connections, such as local area networks (LAN), wide are networks (WAN), over the internet, etc. Such connections can include wired links, such as ethernet, and/or wireless links, such as over 3G, LTE, or Wi-Fi, for example.

The agent-coordinating back-end 15 can include one or more servers configured to coordinate and monitor the status of parcels 3 assigned to agents 13 for delivery in multi-unit dwellings 7. The agent-coordinating back-end 15 includes a communications module allowing communication with agent computing devices 21 and courier service back-ends 17 of cooperating courier services 11. As will be described in more detail hereinafter, the agent-coordinating back-end 15 can send messages to agent 13 via agent computing device 21, including a list of packages that can be accepted by the agent 13 for last-meter delivery. The agent-coordinating back-end 15 can receive messages from the agent 13 via agent computing device 21, including confirmation of parcels that were accepted for last-meter delivery by the agent 13 and delivery status of such parcels. The agent-coordinating back-end 15 can further receive messages from courier service back-end 17 including information relating to parcels that are available for delivery or to be delivered. Moreover, the coordinating back-end 15 can send messages to the courier service back-end 17 including delivery status updates relating to parcels assigned to agents 13. Information relating to parcels and/or their delivery status by agents 13 can be stored in an agent-coordinating database 25 accessible via the back-end 15.

Courier service back-ends 17, 17′ can include one or more servers configured to coordinate and monitor the status of parcels 3 within different courier service networks 11, 11′. The courier service back-ends 17, 17′ include communications modules allowing communication with courier mobile devices 19, 19′. The communications module of the courier service back-end 17 of a cooperating courier service can also allow communication with the agent-coordinating back-end 15. As will be described in more detail hereinafter, the courier service back-ends 17, 17′ can send messages to couriers 9, 9′ within their respective networks 11, 11′ via courier mobile devices 19, 19′, including information relating to parcels 3 assigned to the couriers 9, 9′ for delivery and/or for pick-up. The courier service back-ends 17, 17′ can further receive messages from their couriers 9, 9′ via courier mobile devices 19, 19′ including updates on the delivery status of parcels 3. The courier service back-end 17 of a cooperating courier service 11 can also send messages to agent-coordinating back-end 15, including information relating to parcels that are available to be assigned to an agent. Moreover, the courier service back-end 17 can receive messages from agent-coordinating back-end 15, including delivery status updates on parcels that are assigned to an agent. Information relating to parcels and/or their delivery status within the courier networks 11, 11′ can be stored in a courier service database 27, 27′ accessible via the back-ends 17, 17′. The courier service back-ends 17, 17′ can further implement APIs allowing parcel delivery status to be requested, and/or to allow scheduling parcel pick-ups.

Courier mobile devices 19, 19′ correspond to one or more mobile computing devices provided to couriers 9, 9′ while on their delivery route. The courier mobile devices 19, 19′ are configured to facilitate parcel delivery by allowing parcels to be identified, and allowing delivery information relating to the parcel to be received from the courier service back-ends 17, 17′ and presented to the couriers 9, 9′. The courier mobile devices 19, 19′ can further allow reporting delivery status information relating to a parcel 3 to courier service back-ends 17, 17′. A courier mobile device 19, 19′ can include a scanning module for scanning parcel information associated with a parcel. The scanning module can, for example, include an optical or infrared scanner for scanning a label or barcode affixed to the parcel and containing parcel information, such as a unique identifier or other parcel identifying data. The courier mobile device 19, 19′ can further include a communications module, for example including a wireless radio, to send and/or receive information relating to the identified parcel from the courier service back-ends 17, 17′. The courier mobile devices 19, 19′ can further include a user interface module, for example including a display and an input device such as a keypad and/or touchscreen, in order to allow the courier 9, 9′ to be presented with parcel delivery information, such as the destination address, and/or in order to input parcel delivery information, for example to update the delivery status. The courier mobile devices 19, 19′ can correspond to any suitable mobile computing devices that include the modules described above, such as a smartphone and/or a specialized portable barcode scanning device. As can be appreciated, the courier mobile devices 19, 19′ can include memory and a processor for running specialized software for managing deliveries within the respective courier networks 11, 11′. As can be further appreciated, the courier mobile devices 19, 19′ can be configured to implement additional modules and/or functionalities as needed to carry out deliveries within the respective courier networks 11, 11′.

Agent computing device 21 corresponds to a computing device that allows agent 13 to communicate with the agent-coordinating back-end 15 in order to be assigned parcels and to provide updates on the delivery status of parcels. The Agent computing device 21 can further allow agent 13 to communicate directly with the back-end 17 of cooperating courier service 11, for example to schedule a parcel pick-up. The agent computing device 21 can include a scanning module for scanning parcel information associated with a parcel. The scanning module can, for example, include an optical or infrared scanner for scanning a label or barcode affixed to the parcel and containing parcel information, such as a unique identifier or other parcel identifying data. The agent computing device 21 can further include a communications module, for example including a wireless radio, to communicate with the agent-coordinating back-end 15 and the back-end 17 of cooperating courier service 11. The agent computing device 21 can further include a user interface module, for example including a display and an input device such as a keypad and/or touchscreen, in order to present information to and receive input from agent 13. The agent device 21 can correspond to any suitable computing device that includes the modules described above, such as a smartphone or tablet, or other mobile computing device. As can be appreciated, the agent device 21 can include memory and a processor for running a native or web-based application for interacting with agent-coordinating back-end 15 and/or the back-end 19 of cooperating courier service 11. The application can be configured to cache delivery information such that deliveries can be completed even though the agent device 21 does not have an active connection to back-end 15. Such cached information can be uploaded and/or updated once connection with back-end 15 is restored.

The recipient computing device 23 corresponds to a computing device that allows recipient 5 to interact with the back-end 17, 17′ of the courier service 11, 11′ responsible for the delivery of their parcel 3. The recipient computing device 23 can include a smartphone, tablet, laptop computer, desktop computer, or other similar device running a native or web-based application for interacting with the courier service back-ends 17, 17′. A recipient 5 can, for example, use their recipient computing device 23 to obtain parcel tracking status from back-ends 17, 17′. The recipient computing device 23 can also be used to provided delivery preferences and/or to provide modified delivery instructions to service back-ends 17, 17′ if such features are offered as part of the courier services 11, 11′. As can be appreciated, in the systems and methods described herein, the recipient 5 can interact with their courier services 11, 11′ via their recipient device 23 as they normally would, such that the use of an agent 13, agent device 21, and agent-coordinating back-end 15 is transparent to the recipient 5.

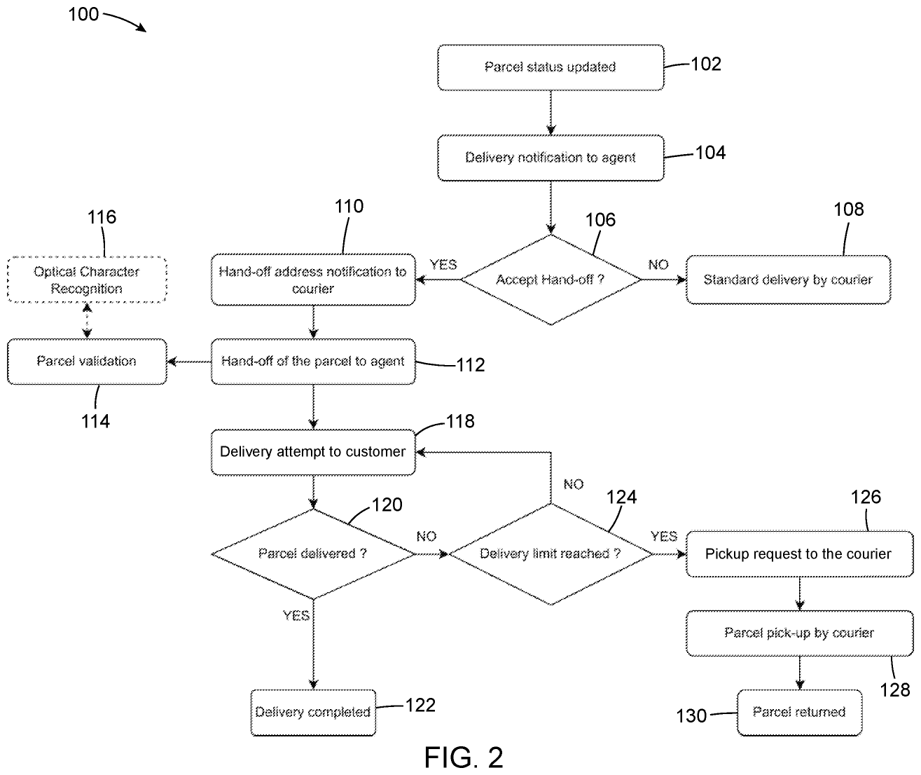

With further reference to FIG. 2, an exemplary method 100 for parcel delivery carried out using the system 1 will be described. The method 100 starts at step 102 in which the parcel 3 is ready for last-mile delivery to the destination address. For example, the status of the parcel 3 can be updated in courier back-end 17 as being “Out for delivery”, or an equivalent, corresponding to the parcel being loaded on a delivery truck of a courier 9, and en-route to the final delivery address associated with the parcel. Typically, such statuses are updated in the morning as couriers load parcels on their delivery trucks and start their delivery routes. In particular, when loading a delivery truck, identification information on parcel 3 can be scanned using courier mobile device 19 which can then send a message to courier service back-end 17 to update the status of parcel in its database 27. Information relating to parcels that are ready for last-mile delivery are communicated to agent coordinating back-end 15 so that they can be assigned to an agent.

In the present embodiment, information relating to parcels that are ready for last-mile delivery can be pushed from courier service back-end 17 to agent coordinating back-end 15 via an API exposed by agent coordinating back-end 15. Such information can be sent individually, for example each time tracking status of a parcel is updated in courier service back-end 17, or grouped in batches, for example for a plurality of parcels at a predetermined time and/or at predetermined intervals. In some configurations, the courier service back-end 17 can send information for all parcels to agent coordinating back-end 15, whereas in other configurations, the courier service back-end 17 can determine whether a parcel is eligible for being assigned to an agent before sending corresponding information to agent coordinating back-end 15. Although a push configuration is used in the present embodiment, it is appreciated that in other embodiments a pull configuration can be used where information relating to parcels that are ready for last-mile delivery can be pulled by the agent coordinating back-end 15 from courier service back-end 17 via an API exposed by courier service back-end 17.

At step 104, a delivery notification is sent from the agent coordinating back-end 15 to one or more agent computing devices 21. The delivery notification indicates to the agent 13 that one or more parcels are available to be accepted by that agent 13 for last-meter delivery. The delivery notification can include information regarding the delivery, such as the number of parcels, the weight of parcels, estimated time of arrival of the courier 9, the delivery address, and monetary compensation for the delivery, for example.

In the present embodiment, delivery notifications are sent only to agents who are eligible to handle the last-meter delivery of a parcel 3. An eligible agent corresponds to an agent who is recorded in the database 25 of agent-coordinating back-end 15 as having access to the multi-unit dwelling corresponding to the destination address of the parcel. Accordingly, step 104 includes determining one or more eligible agents for handling the last-meter delivery of a parcel 3, prior to sending a delivery notification to only the determined agents. As can be appreciated, determining eligible agents can be carried out in any suitable manner. For example, the agent-coordinating database 25 can store an association between agents and a range of addresses corresponding to one or more multi-unit dwellings to which each agent has access. For each parcel that is ready for last-mile delivery, the agent-coordinating back-end 15 can determine whether the destination address of said parcel falls within the address range associated with one or more agents. If the destination addresses of a parcel falls within the address range of one or more agents, delivery notifications can be sent to the agent computing devices 21 of those agents. If the destination address of a parcel does not fall within the address range of any agent, it can be determined that no eligible agents available, and a notification will not be sent to any agents. In some embodiments, additional criteria can be taken into account when determining eligible agents. For example, agents can be specified in the agent-coordinating database 25 as being eligible to handle last-meter deliveries of parcels for only one or more predetermined courier services. For example, for a given multi-unit dwelling, a first agent can be eligible to accept delivery of parcels for a first courier services, whereas a second agent can be eligible to accept delivery of parcels for a second courier service. Further, in some configurations, only one agent can be associated with a range of addresses, for example when the agent is a concierge for the multi-unit dwelling and deliveries are to be handled by the concierge. In such configurations, only this agent can allowed or capable of receiving parcels for delivery within the multi-unit dwelling, for example.

In other configurations, agents can be assigned to a “parcel pick up point”, corresponding to a designated delivery location (such as a third-party business) where parcels can be left off by a courier for a recipient to come pick up. In such cases, the parcel pick up point can be associated with a range of addresses, and the agent assigned to the parcel pick up point can be determined as eligible for last-meter delivery when a parcel could not be delivered to its destination address, and when the destination address matches the range of addresses associated with the parcel pick up point In some embodiments, the agent assigned to the parcel pick up point can be determined as eligible when the recipient requests that their parcel be delivered to the parcel pick up point instead of to the recipient's address.

As can be further appreciated, the destination address associated with a parcel can be formatted differently by different carriers and/or can be subject to variation depending on how it was initially provided by the sender. Accordingly, the method may include a translation process, whereby the destination addresses of parcels as received from courier back-end 17 are translated before being matched with potential agents. For example, in some embodiments the addresses and ranges stored in agent coordinating database 25 can be normalized, and the parcel destination addresses received from courier back-end 17 can be normalized before being matched to addresses stored in the coordinating database 25. In some embodiments, the agent coordinating back-end 15 can employ pattern matching and/or fuzzy logic techniques to match addresses received from courier back-end 17 with those stored in coordinating database 25.

In some embodiments, separate notifications can be sent for each individual parcel eligible for delivery. In other embodiments, parcels can be grouped into jobs, and a single notification can be sent for a job containing a plurality of parcels. For example, a plurality of parcels destined for delivery to different units of the same multi-unit dwelling can be grouped into a job, and a single notification can be sent for that job.

At step 106, the notification is presented to agent 13 via the agent computing device 21, and the agent may accept or refuse to handle the last-meter delivery of any number of parcels by providing an input via the agent computing device 21. For example, each delivery notification can provide options for accepting and for refusing a parcel delivery. If no available agent accepts a given parcel, delivery of the parcel can be completed by the courier at step 108 according to their usual delivery practice, meaning that the courier will deliver the parcel at the delivery address if possible, or otherwise at a designated area, for example, without involving an agent.

When a parcel is accepted by an agent 13, the agent computing device 21 can send an acceptance message to the coordinating back-end 15 which in turn can notify the courier back-end 17 that an agent is available to handle the last-meter delivery of the parcel, while providing delivery information associated with the agent. At step 110, the courier back-end 17 can reroute the parcel to the agent using the received delivery information, and notify courier 9 via their courier device 19 that the delivery address has changed to an address associated with the agent 13. That is, the address of the agent 13, or intermediate address, becomes the delivery address at which the courier is to deliver the parcel. At step 112, the parcel 3 gets handed off by the courier 9 to the agent 13. Handing off the parcel to the agent instead of attempting delivery of the parcel directly to the recipient allows for avoiding the risk of the recipient not being present, or the courier being unable to reach the delivery address. Where parcels are grouped into jobs, it also allows the courier 9 to hand off multiple parcels to a single agent 13 instead of having to contact and attempt delivery to multiple individual recipients.

When the parcel 3 is handed off to the agent 13, a scanning step 114 is performed to validate and/or confirm identification of the parcel, and further to update the status associated with the parcel 3. When handing off the parcel 3, the courier 9 can physically scan the parcel label, such as a barcode located on a parcel label, using their courier device 19, in order to read parcel information. Once the parcel is scanned and the parcel information is obtained, such information can be sent to the courier back-end 17 in order to update the delivery status of the parcel to “tendered to agent”, or any equivalent indicating that the parcel has been handed off to an agent. The agent 13 can also physically scan the parcel label using their agent device 21 and forward parcel information to the agent coordinating back-end 15. This can allow confirming in the coordinating back-end 15 that the parcel is in the possession of the agent 13 for subsequent tracking purposes. In some embodiments, the coordinating back-end 15 can notify the courier back-end 17 of the scan by the agent 13, for example such that the status of the parcel can be updated in the courier back-end 17 as being “Accepted by agent”, or any equivalent indicating that the parcel has been successfully accepted by the agent. In some embodiments, the parcel can be scanned using agent device 21 while the agent device does not have an active connection with the coordinating back-end 15. In such embodiments, the scanned information can be cached in local storage on the agent device 21 and sent to coordinating back-end 15 once the connection is restored.

In some configurations, the parcel information can also be communicated to a third party, such as a management software used to manage the multi-unit dwelling. For example, existing software can be used within the multi-unit dwelling to communicate with recipients, such as by email, by phone, by a dedicated application, etc., when a parcel is received at the dwelling's entrance, and/or to indicate that the parcel is ready for pick-up at a given storage location within the building, for example. In such cases, the agent device can communicate the scanned parcel information with the management software, such as using APIs of the management software, to confirm residency of the recipient, or to automatically record said parcel information in the management software, for example.

In some scenarios, it is possible that information relating to parcels out for last-mile delivery is incomplete and/or missing from the coordinating back-end 15. This can occur, for example if a courier forgets to scan a parcel when loading their truck, or if a parcel is being delivered by a non-cooperating courier service 11′. Further, some parcels may not have an online presence, meaning that no status or electronic identification is associated with the parcels in courier back-end 17. For example, parcels detailed in manual waybills written by hand may not have associated electronic delivery information stored in courier database 27. In such cases, the parcels may still be handed off to an agent, but parcel information can be manually entered such that delivery by agent 13 can be tracked by coordinating back-end 15. In some embodiments, the agent 13 can be presented with a form on agent device 21, allowing the agent 13 to manually input parcel delivery information, such as the delivery address and the courier from which the parcel was received. In some embodiments, a step 116 can include scanning the parcel label using agent device 21 and performing Optical Character Recognition (OCR) to extract usable parcel delivery information from an image of the parcel label. The collected parcel delivery information can subsequently be transmitted to coordinating back-end 15 so that the parcel can be entered in the coordinating database 25 and tracked thereafter by the coordinating back-end 15. In some embodiments, the parcel delivery information can be collected while the agent device 21 does not have an active connection with the coordinating back-end 15. In such embodiments, the parcel delivery information can be cached on local storage of the agent device 21 and uploaded to the coordinating back-end 15 once the connection is restored.

Once the parcel has been handed off to the agent 13, delivery of the parcel to the final destination (i.e., the unit address of recipient 5 as indicated in the original delivery address) is performed by the agent 13 at step 118. If the parcel can be dropped at a safe location, the agent 13 may simply drop the parcel at the recipient's door. In such a case, the method includes updating the status associated with the parcel to “Delivered”. The status can be updated, for example, by scanning the parcel label using agent device 21 and sending a message to the coordinating back-end 15 to confirm that the parcel was dropped at a safe location. The message can be sent immediately if the agent device 21 has an active connection with coordinating back-end 15, or at a later time once the connection is restored. The coordinating back-end 15 can subsequently inform the courier back-end 17 that the parcel was dropped off such that the parcel status can be updated as needed in the courier database 27. Once the parcel status has been updated to indicate that the parcel was delivered, the delivery is completed at step 122. The coordinating back-end 15 can subsequently initiate electronic payment to compensate the agent 13 for carrying out the delivery according to the accepted terms, using agent payment information stored in coordinating database 25.

Alternatively, when the parcel is handed off to an agent assigned to a parcel pick up point the agent, using the agent device, can update the parcel status to “Ready for pick-up”, or the like. The coordinating back-end can subsequently notify the recipient (e.g., via the courier back end) that their parcel is ready for pick-up at the designated parcel pick up point. Once the recipient picks up the parcel, the agent can scan the parcel information and update the status of the parcel to “Delivered”.

Further, as mentioned above, in some configurations, an existing management software can be used to manage deliveries within a building. In such cases, when the parcel is handed off to the agent, the parcel information is communicated with the management software, which can subsequently inform the recipient that the parcel is ready for pick-up. The last-meter delivery, in such configurations, can comprise storing the parcel in a designated storage area that can be accessed by the recipient to retrieve the parcel and/or having the parcel delivered by a concierge, for example. Therefore, the status of the parcel can be updated to “Ready for pick-up” by the agent, using the agent device, once the parcel is recorded within the management software or stored in the designated storage area. Alternatively, the agent coordinating back-end can provide APIs which the management software can use to automatically update the status associated with the parcel to “Delivered” once the recipient has been contacted, once the parcel has been stored in the designated storage area, and/or once the parcel has been delivered by a concierge, for example.

If the parcel must be delivered in person, the agent 13 can attempt to contact the recipient 5 to complete the in-person delivery. If the recipient 5 is not present to receive the parcel, the parcel is not delivered, and another delivery attempt can be planned. In the present embodiment, the method includes limits for attempted delivery at step 124, after which the parcel is to be returned to the courier service 11 for subsequent handling. In particular, the method can include a time limit or an attempt limit for delivering the parcel, after which the agent 13 is provided with an indication via agent device 21 that the parcel should be returned to the courier service 11. For example, after a second unsuccessful attempt at delivering the parcel, or after being in possession of the parcel for five days, the agent 13 can be notified that the parcel is to be returned to the courier. Step 126 includes generating and sending a pickup request to the courier service 11 to dispatch a courier 9 to picking up the parcel. In the present embodiment, the agent device 21 is configured to communicate directly with the courier back-end 17 to request parcel pickups, for example using an API exposed by the courier back-end 17. In other embodiments, the agent device 21 can configured to communicate with coordinating back-end 15 that interacts with the courier back-end 17 to request parcel pickups. When sending a pickup request to courier back-end 17, the pickup address can be the agent's address, or any other address indicated by the agent. The pickup request can also specify a desired pickup time, depending on the availability of courier network 11.

In some embodiments, instead of requesting a parcel pick-up, the method can include dropping the parcel at a designated area, such as a parcel pick up point, that can be subsequently accessed by the recipient to retrieve the parcel, when delivery attempts are unsuccessful. In such embodiments, the method can include updating the parcel status to “Ready for pick-up” with the address of the parcel pick up point, and an agent at the parcel pick up point can initiate the return to the courier service if the parcel has not been picked up within a required timeframe.

At step 128, a courier 9 arrives at the pickup address at the time specified in the pickup request, if specified. The parcel can then be handed off from the agent 13 to the courier 9. When performing the hand-off, the agent 13 can scan the parcel label using agent device 21 and send a message to the coordinating back-end 15 confirming that the parcel was handed off to a courier 9. The coordinating back-end 15 can further notify the courier back-end 17 such that the tracking information in the courier back-end 17 can be updated accordingly. The parcel label can further be scanned by courier 9 using courier device 19 and communicated to courier back-end 17 such that the tracking information can be updated to reflect that the parcel was successfully accepted for return by the courier 9. The parcel can be subsequently returned to the sender or to the courier's warehouse as per the courier's standard return process. Once the parcel has been picked up by the courier 9, the return is completed at step 130. In some embodiments, the coordinating back-end 15 can initiate electronic payment to compensate the agent 13 for attempting delivery according to the accepted terms, using agent payment information stored in coordinating database 25.

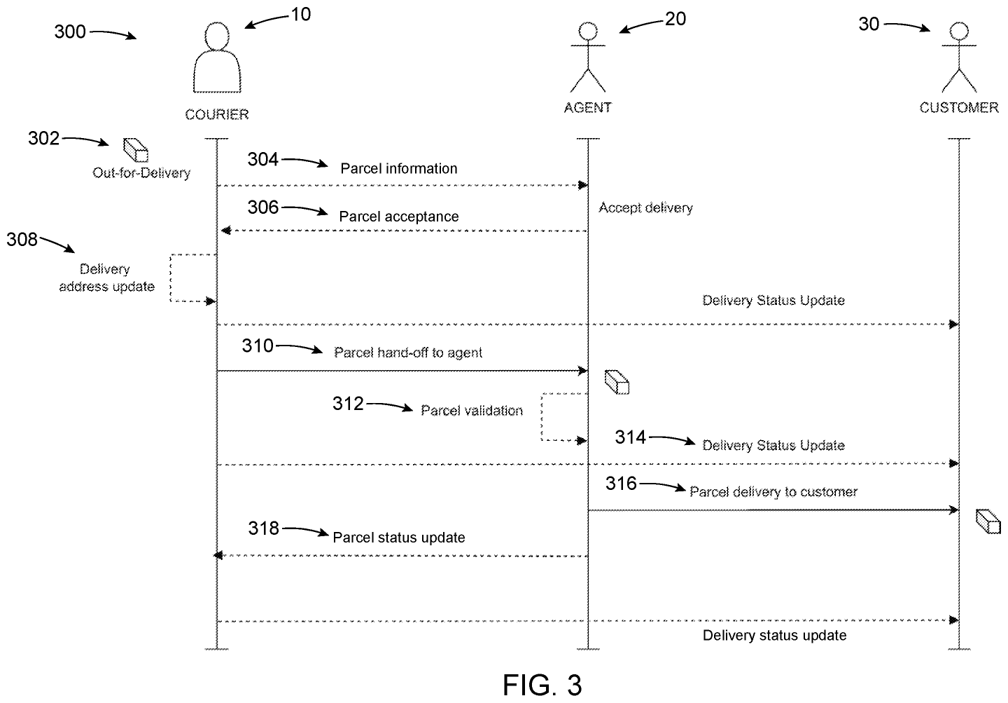

As can be appreciated, the method 100 described above involves an exchange of messages between computing components of different entities. Such entities include a courier service (which includes courier back-end 17 and courier device 19), an agent service (which includes agent coordinating back-end 15 and agent device 21), and a recipient (including recipient device 23). With reference to FIG. 3, a sequence diagram illustrating the exchange of messages between a courier service 10, an agent service 20 and a recipient 30 is shown in connection with an embodiment of a method 300 for delivering parcels to a multi-unit dwelling in which a parcel is handed off to an agent and thereafter delivered to a recipient.

The process 300 starts with a parcel status being updated to “Out-for-delivery” 302 by courier service 10, for example following a scan of the parcel when it is loaded on a courier delivery vehicle. Once the parcel status is updated to “Out-for-delivery”, a message comprising information associated with the parcel 304 is sent to the agent service 20, for example using an API exposed by the agent service 20.

The agent service 20 can then determine whether an agent is available to accept the parcel for last-meter delivery. For example, a push notification can be sent to all eligible agents via their agent computing devices. As can be appreciated, a push notification for a given parcel can be sent to a plurality of agents. For example, in one configuration, two or more agents may live in a same condominium, and accordingly, when a parcel is destined for delivery to an address within said condominium, both agents will receive a notification. In another configuration, only one agent can be assigned to an address range, e.g., the condominium, and therefore only this agent can receive a notification when parcels are to be delivered to an address within the condominium. Once an agent accepts to handle the last-meter delivery, the agent service 20 can send a parcel acceptance message 306 to the courier service 10, for example via an API exposed by the courier service 10. The parcel acceptance message can indicate that an agent is available to handle last-meter delivery while also providing information relating to the agent, such as the agent's identity and a hand-off address specified for the agent to accept hand-off of the parcel. In some embodiments, the hand-off address can be the personal residential address of the agent. However, different addresses can be used. For example, the hand-off address can correspond to a common area of the multi-unit dwelling, or a general pick-up location specified by the courier service 10 or by the agent service 20.

In response to receiving the acceptance message 306, the courier service 10 can reroute the parcel in its system 308, for example by updating the delivery address for the parcel such that it matches the hand-off address specified in the acceptance message. The rerouting of the parcel can be communicated to the courier handling the parcel via their courier mobile device. For example, upon scanning the parcel label, the courier mobile device can display the hand-off address as the new delivery address.

As can be appreciated, parcel acceptance 306 and parcel rerouting 308 can be implemented using different mechanisms. For example, in some embodiments, the parcel acceptance message 306 can correspond to a request to the courier service 10 to reroute the parcel via an API exposed by the courier service 10. As part of the API request, the courier service 10 can confirm to the agent service 20 that the rerouting was successful, and thus that the courier service 10 has accepted to instruct their courier to hand off the parcel to the specified agent.

Once the delivery address has been updated to the hand-off address 308, a courier of the courier service 10 physically delivers the parcel 310 to the agent at the specified hand-off address. Upon receiving the parcel, the agent, through the agent service 20, can proceed to validate the parcel 312, which can include physically scanning the parcel label to confirm the correct parcel was received and/or to confirm the parcel delivery information. In some embodiments, parcel validation 312 can also include updating the parcel status in the courier service 10 and/or agent service 20 systems. For example, once the parcel is handed off to the agent of the agent service 20, the courier can scan the parcel and the parcel status may be updated in the tracking system of courier service 10 as being to “Handed off to agent”, or any equivalent.

Following the handing off and the parcel validation, the agent assigned by the agent service 20 attempts physical delivery of the parcel to the delivery address originally associated with the parcel. For example, the delivery address may be a unit located in the same dwelling as the agent. If the recipient 30 is present at the time of delivery, the delivery is completed 316 by the agent service 20. A proof of delivery, such as a signature from the recipient, can be recorded to the agent service 20, for example via the agent device.

The agent service 20 can subsequently send a message to courier service 10 to update the parcel status 318, for example via an API exposed by the courier service 10. The status update message can indicate that the parcel has been delivered to the recipient 30 such that the courier service 10 can update its internal tracking status. In some embodiments, the status update message can include a copy of the proof of delivery obtained by the agent service 20.

As can be appreciated, when attempting delivery, it is possible that the recipient 30 may not be physically present at the delivery address to accept the parcel. In some scenarios, when the recipient 30 is not present, the parcel may be left at a safe location, for example at the door of the recipient's unit. When the parcel cannot be delivered, such as when the recipient 30 is not present and the parcel cannot be left unattended, the agent can perform further delivery attempts. For example, the agent may attempt delivery at another time of the day, or on the following day. To facilitate managing the parcel status and inventory, the agent service 20 can be adapted to keep track of every parcel received by the agent service 20 and handed off to the agent and not yet delivered to the recipient 30. In some embodiments, a parcel status update message can be sent from agent service 20 to courier service 10 each time a parcel delivery is attempted such that the courier service's tracking status can be updated accordingly.

As can be appreciated, throughout the process 300 described above, recipient 30 can communicate directly with courier service 10 in order to obtain up-to-date tracking status of their parcel using a tracking number or other identified provided by courier service 10. The tracking status can be provided, for example, by querying an API exposed by courier service 10 and/or using a native or web-based tracking application provided by courier service 10. In this fashion, the recipient 30 can track their parcel with the courier service 10 as they normally would without needing to interact with the agent service 20 in any way. As can be appreciated, the tracking status of parcel can be provided by courier service 10 at different levels of granularity based on status updates that the courier service 10 receives from the agent service 20. For example, if the recipient 30 requests a tracking status from the courier service 10 before the parcel is assigned to an agent, the tracking status can be indicated as being “Out for delivery” or an equivalent. If the recipient 30 requests a status update 309 after the parcel is assigned to an agent, the tracking status can be indicated as being “Assigned to agent”, or an equivalent, and may provide an indication as to the specific agent to which the parcel is assigned. If the recipient 30 requests a status update 314 after the parcel is handed off to the agent, the tracking status can be indicated as being “Handed off to agent”, or an equivalent, and may provide an indication as to the specific agent to which the parcel was handed off. Finally, if the recipient 30 requests a status update 319 after delivery of the parcel was attempted, the tracking status can be indicated as being “Delivery attempted” or “Delivery completed”, or an equivalent, depending on the outcome of the delivery attempt.

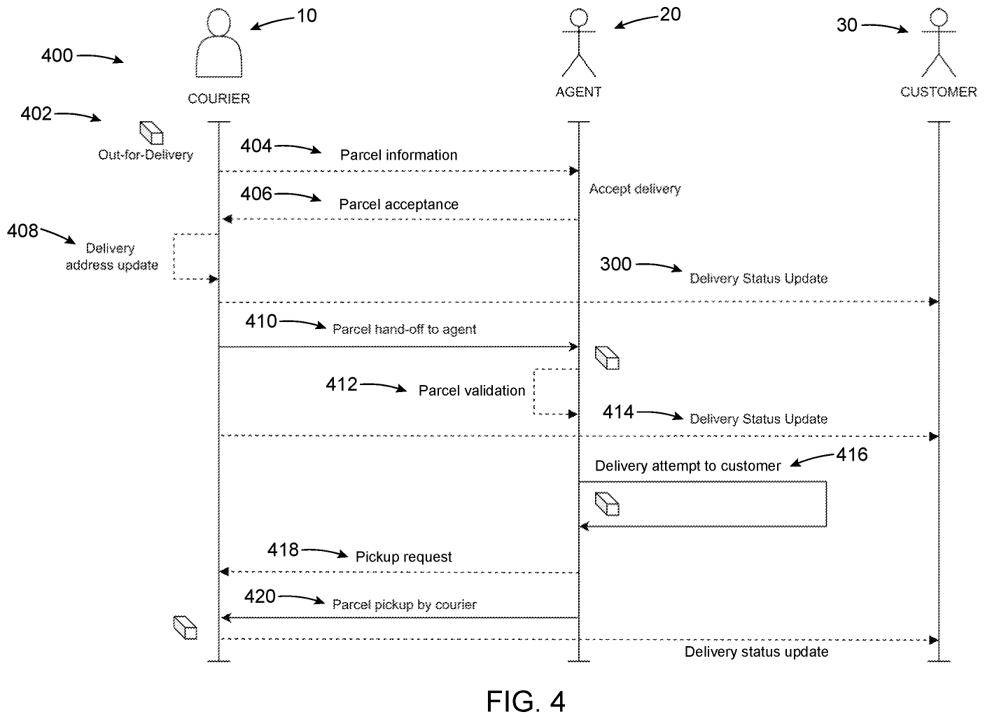

In some embodiments, when the parcel cannot be delivered to the recipient 30, or when the recipient 30 refuses delivery of the parcel, the parcel can be returned to the courier service 10 for subsequent processing through their network. With reference to FIG. 4, a sequence diagram illustrating the exchange of messages between a courier service 10, an agent service 20 and a recipient 30 is shown in connection with an embodiment of a method 400 for delivering parcels to a multi-unit dwelling in which a parcel is returned to courier service 10 after the parcel cannot be delivered by the agent. In the illustrated embodiment, steps 402 to 413 correspond to steps 302 to 313, respectively. As mentioned above, once the parcel has been handed off to the agent service 30, delivery to the recipient 30 is attempted. When delivery is unsuccessful, it may be attempted again. However, the parcel can be associated with a delivery limit, such as a delivery time limit and/or a delivery attempt limit. For example, a two-day time limit or a two-attempt limit prevents the agent of the agent service 20 from having to attempt delivery repeatedly when the recipient 30 is not reachable. Once a delivery limit is reached, the agent can send a pickup request 418 to the courier service 10, requesting to schedule a pick up of the parcel by the courier so that the parcel return process can be handled by the courier service 10. The pickup request message 418 can, for example, be sent by the agent service 20 through an API exposed by the courier service 10. In some embodiments, the agent service 20 can automatically send a pickup request 418 to the courier service 10 once the delivery limit is reached. However, in some embodiments, the pickup request message 418 can be manually initiated by an agent, for example using their agent computing device. The pickup request 418 can include information identifying the parcel, and further information such as the number of packages, weight and pickup address, for example. As part of the API call for sending the pickup request 418, the courier service 10 can confirm to the agent service 20 that the pickup request was accepted and successfully scheduled. In some embodiments, the tracking status in courier service system can be updated to reflect that the parcel is awaiting pickup.

Once a pickup is scheduled, a courier can be dispatched by the courier service 10 to pick up the parcel 420 at the scheduled time and location. The status associated with the parcel can subsequently be updated to reflect that the parcel was successfully picked up for return and in the possession of the courier. When the recipient 30 requests a status update from courier service 10, the status can be indicated as “Scheduled for return” or “Picked up for return”, or equivalents.

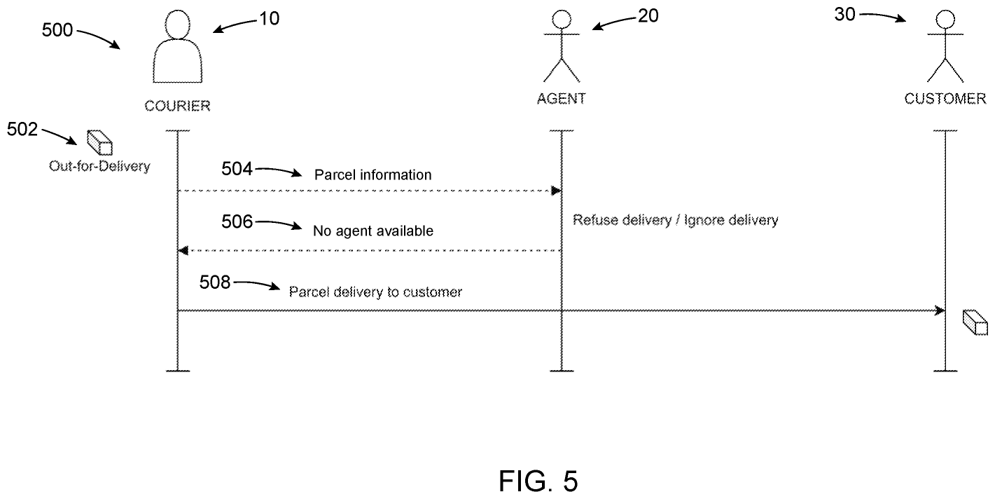

In some scenarios, it is possible that no agent is available to handle the last-meter delivery for a given parcel. With reference to FIG. 5, a sequence diagram illustrating the exchange of messages between a courier service 10, an agent service 20 and a recipient 30 is shown in connection with an embodiment of a method 500 for delivering parcels to a multi-unit dwelling in which no agent is available. In the illustrated embodiment, when the parcel is updated to “Out-for-delivery” at 502, and the parcel information 504 is sent to the agent service 20, the agent service 20 can send notifications to all eligible agents. If there are no eligible agents, or if all available agents ignore and/or refuse to accept the parcel, a refusal message 506 can be sent from the agent service 20 to the courier service 10 to notify the courier service that no agent is available. Such a message can, for example, be sent using an API exposed by the courier service 10. Alternatively, if no agent is available, the agent service 20 can simply not respond to the parcel information message 504, such that courier service 10 will not be requested to reroute the parcel to an agent. When no agent is available, the courier service 10 can proceed with attempting delivery to the recipient 508 as per their usual delivery process, without the involvement of agent service 20.

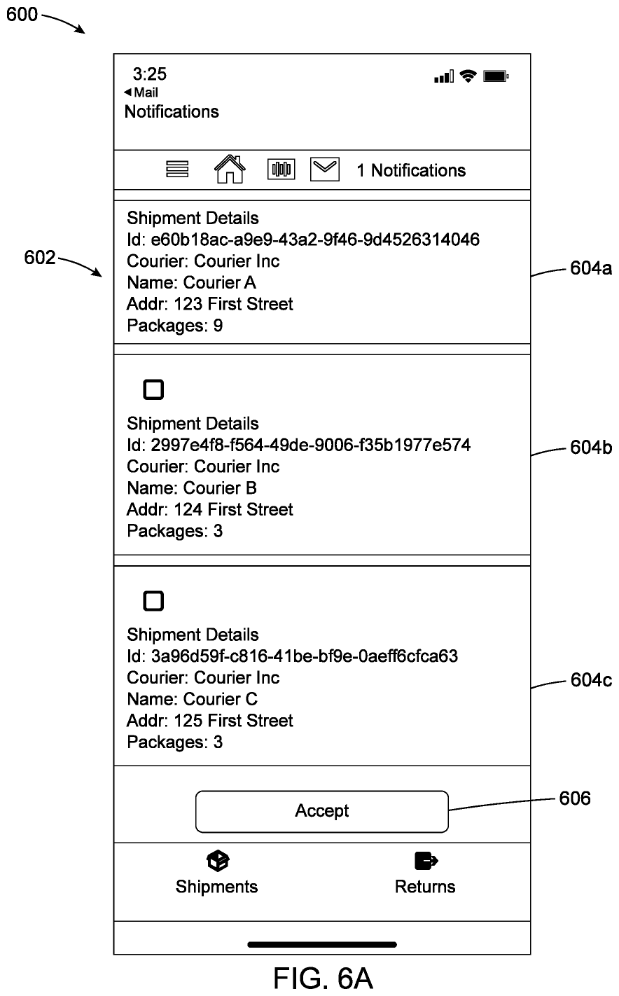

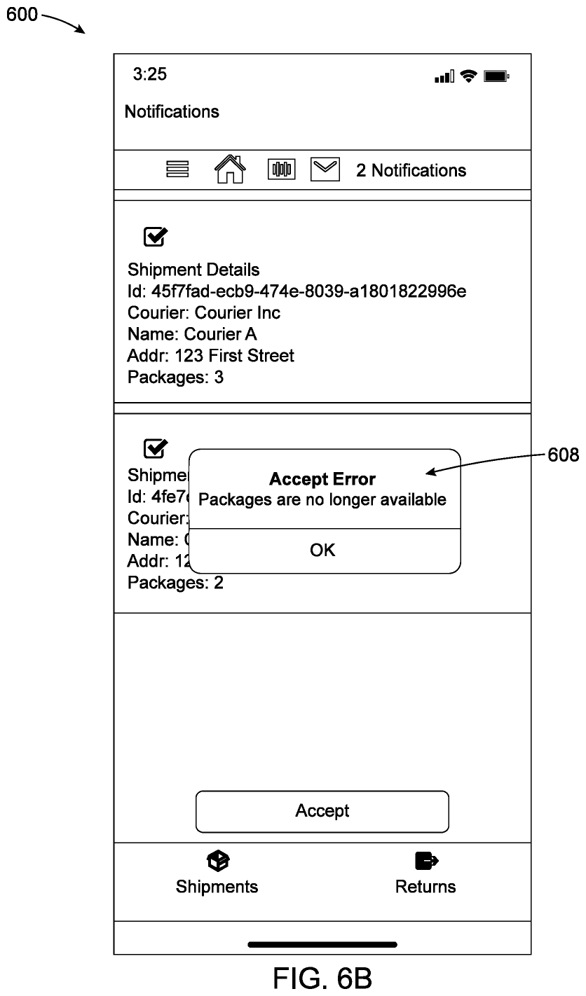

In the embodiments described above, an agent 13 of the agent service 20 utilizes agent device 21 in order to carry out various steps and interact with coordinating back-end 15 and courier back-end 17. The agent 13 can interact with agent device 21 via a user interface generated by the agent device 21, such as a Graphical User Interface (GUI) that can present information to the agent 13 and solicit input from the agent 13. With reference to FIGS. 6A to 14B, various pages of an exemplary GUI generated by agent device 21 are shown according to an embodiment. Such pages can, for example, be generated via a native application running on the agent device 21 and/or on a web-based application accessible via the agent device 21.

Page 600 includes a list 602 of hand-off notifications for every parcel that is out-for-delivery and which the agent is eligible to accept for last-meter delivery. Hand-off notifications 604a-c represent three parcels and/or jobs, each containing one or more parcels to be delivered in the same condominium as the agent, for example. Page 600 allows for visualizing hand-off notifications, and to accept one or more parcels for last-meter delivery. Each of notification 604a-c includes information regarding the parcels/jobs, such as their identification number, the courier name, an identification of the multi-unit dwelling in which the parcels must be delivered (such as the address of the multi-unit dwelling), and the number of parcels included in the job. The agent can interact with the user interface to accept hand-off of any parcel and/or any job containing multiple parcels as displayed on the list 602, by selecting any number of parcels/jobs and pressing the accept button 606, provided the parcel/job is still available. For example, if hand-off of the parcel has been accepted by another agent having also received the hand-off notification, such as another agent living in the same condominium, or if the parcel has already been delivered to the recipient by the courier, an error message 608 can be generated, as shown in FIG. 6B. It should be understood that the list of parcels 602 may include parcels from different couriers that are in communication with the agent coordinating back-end.

When the parcel is being handed off to the agent, page 700 of the user interface allows scanning the parcel label on the parcel. In the present embodiment, page 700 includes a barcode scanner 702 that uses a camera provided on the agent device to scan a barcode on the parcel label 704 that is affixed to parcel. In some embodiments, other technologies may be provided on the parcel label instead of a barcode to be scanned using the barcode scanner 702. For example, as QR codes can be used. in such embodiments, page 700 can include a QR code reader adapted to scan the QR code and interpret information contained therein. It will be understood that other parcel identification technologies can be used without departing from the present disclosure.

Once the parcel label is scanned by the scanner, page 750 can be displayed, confirming the identification of the parcel as read from the label, and allowing the agent device to confirm the status of the parcel. Such a page can be displayed, for example, following a confirmation by the agent device that the identification information corresponds to a parcel that was previously accepted for hand-off by the agent. Page 750 includes an input box for entering the parcel status, and a submit button 754 for submitting the updated parcel status. In the illustrated example, the agent has specified that the parcel was accepted. When submitting the parcel status, the agent device communicates with the agent coordinating back-end to send a message thereto to confirm that the parcel was accepted by the agent.

If upon scanning the barcode, the parcel cannot be identified and/or if it is determined that the parcel does not correspond to a parcel that the agent has accepted for hand-off, an error message 706 can be displayed on page 700. Such a scenario can occur, for example if the parcel does not have electronic information associated therewith, and/or if the parcel information was not communicated to the agent device. Further, if parcels are handed off to the agent from a courier that is not a cooperating courier, the coordinating back-end may not have received parcel information from the courier.

Page 800 allows for manually adding information associated with a parcel, such as information contained on parcel labels. Page 800 includes text fields 802 that can be completed by the agent to add the information manually. Clicking on the submit button 804 submits the information to the agent coordinating back-end so that it can be tracked by the agent coordinating service. Clicking on the Address capture button 806 allows for automatically detecting the information contained on a parcel label using a camera in the agent device and Optical Character Recognition (OCR) software. Upon clicking on button 806, capture panel 850 allows for capturing an image of the parcel label using the agent device's camera. OCR software can translate the information on the image of the parcel label, and page 800 can be displayed again to the agent with the information filled in for confirmation.

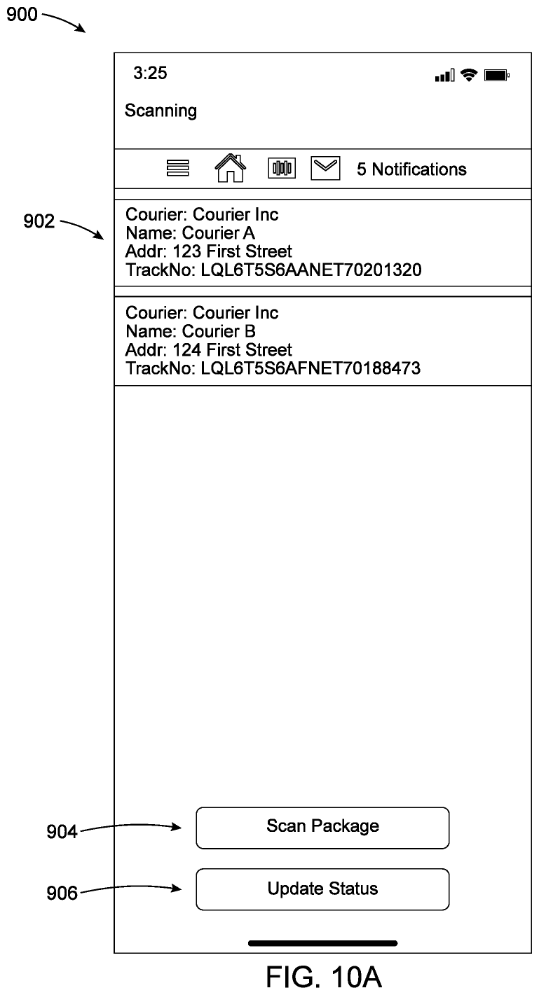

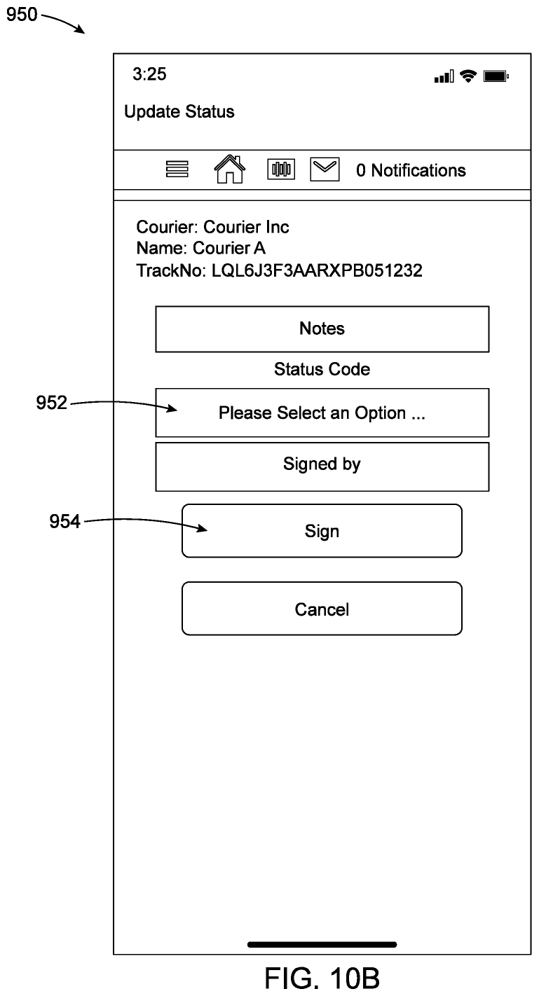

Referring now to FIG. 10A, page 900 is adapted to display a list 902 of all parcels handed off to the agent and scanned/confirmed using the agent device. Scan package button 904 displays page 700, where additional parcels can be scanned and added. Update status button 906 allows for updating the parcel status of one or more selected parcels. Upon clicking on the update status button 906 for a selected parcel in the list 902, page 950 is displayed, allowing for completing the delivery and updating the parcel status. Page 950 includes a drop-down menu 952 for selecting a status of the parcel, such as “Delivered”, “Delivery attempted”, etc. When the status “Delivered” is selected, page 950 can also includes a mandatory sign button 954. By clicking on button 954, page 1000 can be displayed on the agent device, providing a free-form input box 1002 adapted to accept signature of the recipient, acting as proof that the parcel was delivered. Additionally, or alternatively, the device can activate a camera to capture a picture of the parcel delivered to a safe drop area. Once this signature is obtained, the parcel is considered delivered, and the parcel status is updated accordingly. If delivery cannot be completed, because the recipient is not present to accept delivery for example, the status can be updated to “Delivery attempted” via page 950.

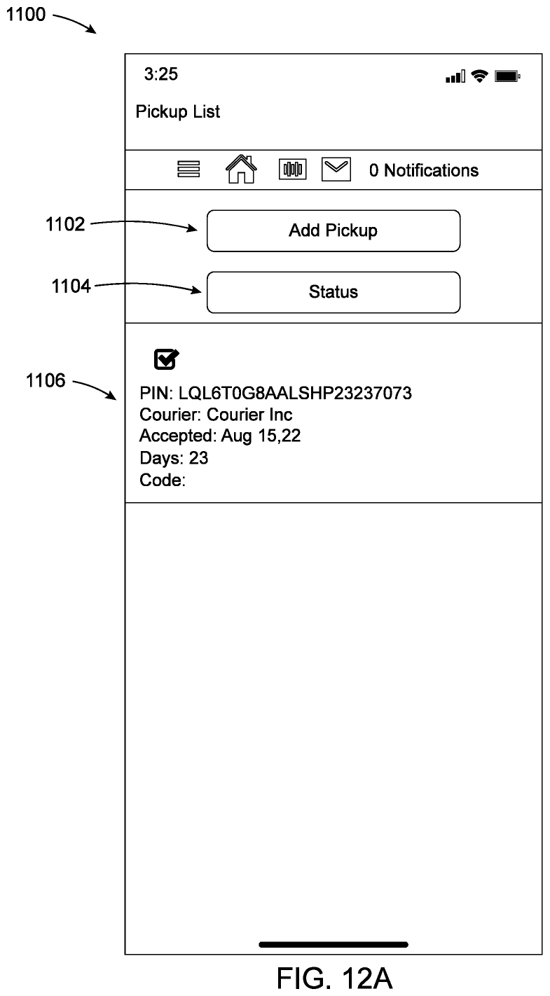

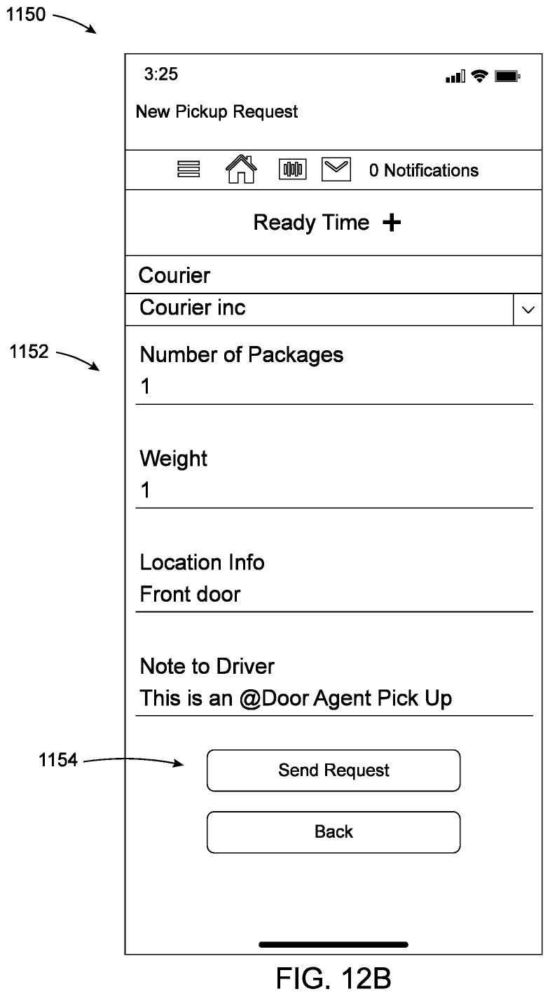

When delivery cannot be completed, the parcel is to be returned to the courier. Referring to FIGS. 12A and 12B, pages 1100 and 1150 are adapted to plan a pickup of the parcel by the courier. Page 1100 displays a list of parcels to be picked up 1106, listing every parcel in the agent's possession for which a pickup was requested, when delivery limit has been reached or when the recipient has refused delivery, for example. Each entry in the list 1106 contains information related to the parcel and to the pickup request, such as the parcel identification number, the courier company and the pickup date, for example. Page 1106 includes a “Status” button 1104, allowing for updating the status of a parcel. Page 1106 also includes an “Add Pickup” button 1102 allowing the agent to add parcels to be picked up. Page 1150 is displayed when button 1102 is pressed. Page 1150 includes text input boxes 1152 adapted to input information related to the parcel to be picked up. For example, the number of packages, the weight of the packages, and the pickup location can be specified using page 1150. The “Send Request” button 1154 is used to send a pickup request to the courier. Such a request can, for example, be sent directly from the agent device to the courier back-end via an API call to the courier back-end.

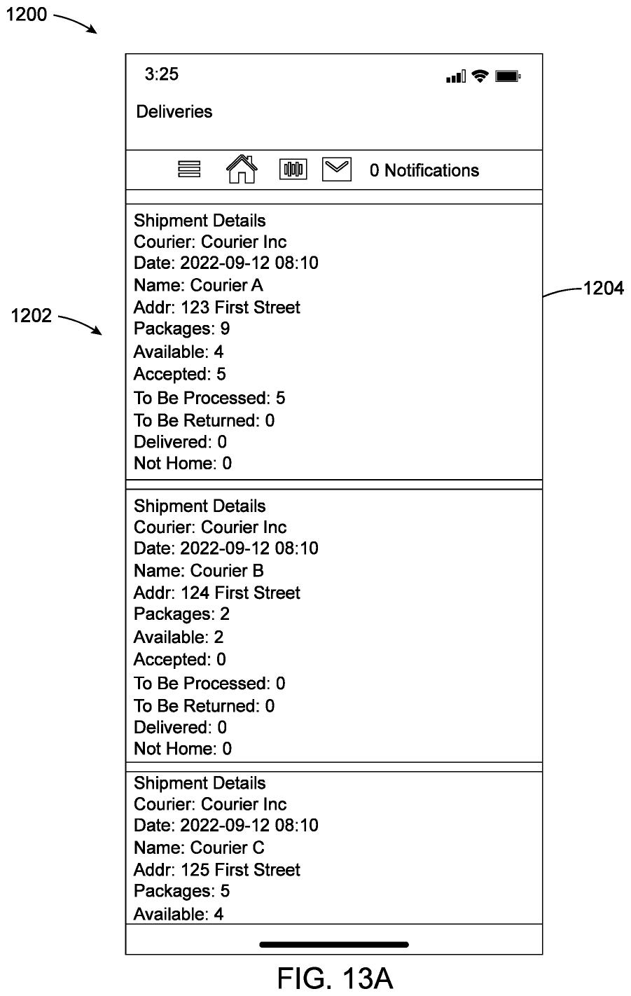

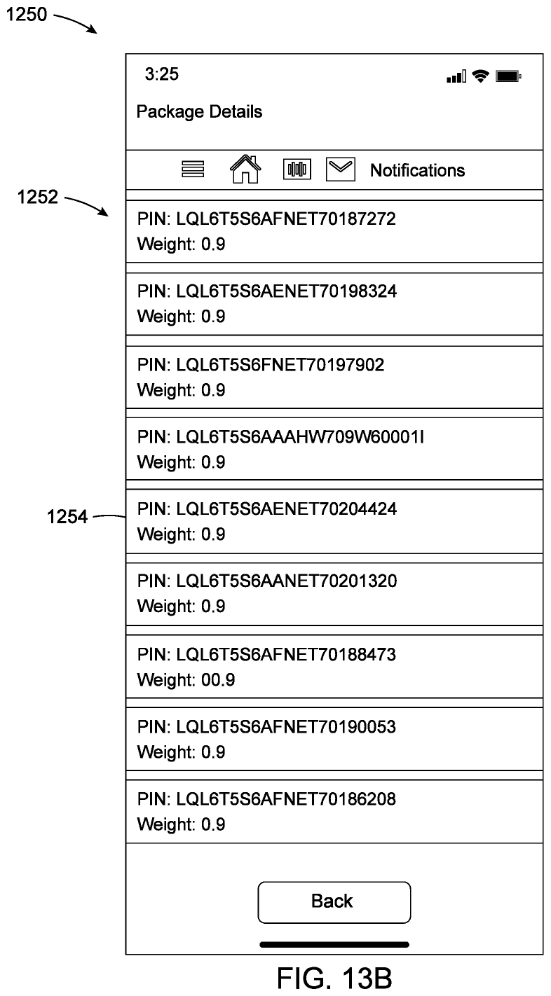

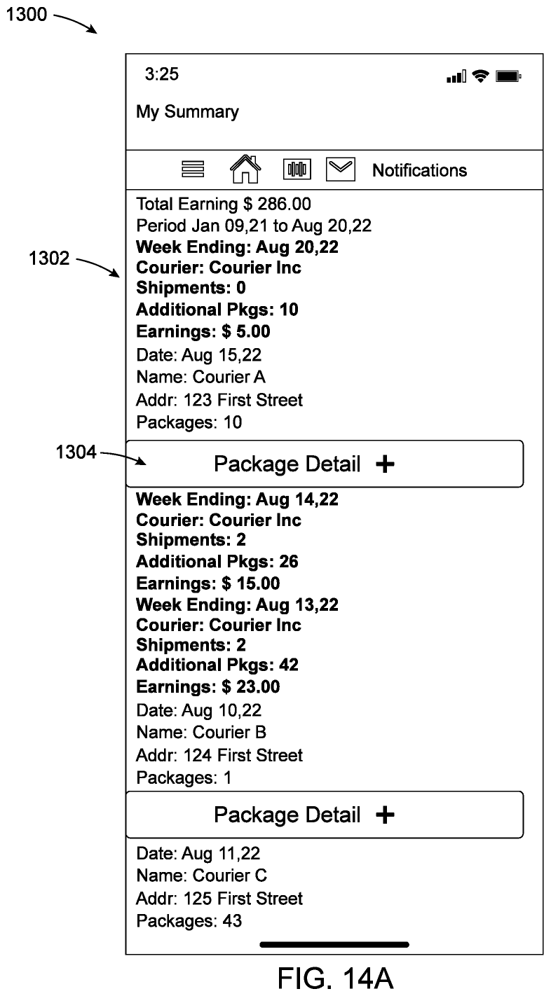

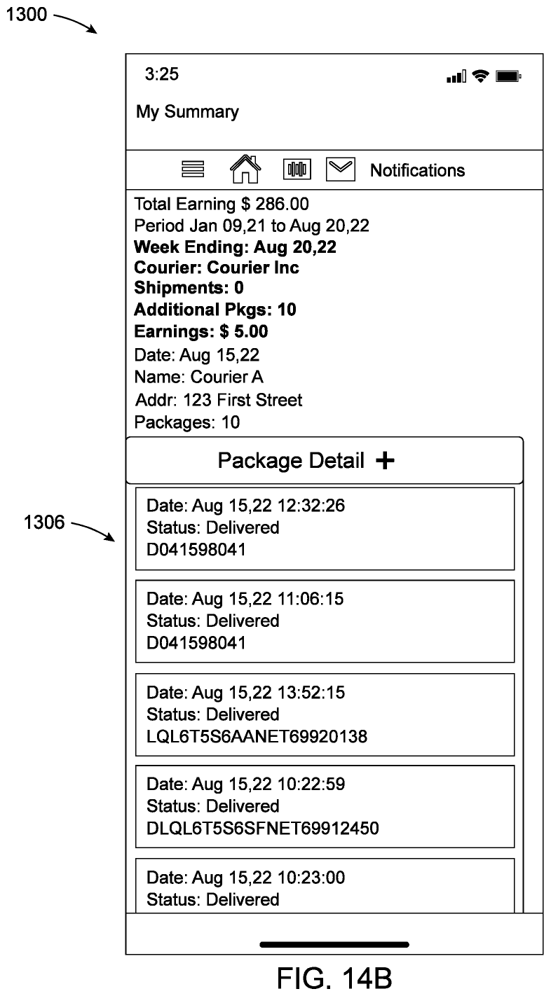

Referring to FIGS. 13A, 13B, 14A and 14B, various pages are available to the agent and adapted to facilitate management of the multiple parcels and related activities. Page 1200 displays a list of parcels 1202 where each entry 1204 is associated to a particular courier. Each entry 1204 includes information related to the parcels associated with a given courier, such as the courier's name, the number of parcels available for hand-off, the number of parcels handed off, the number of parcels to be returned, and the number of parcels delivered by the agent, for example. Page 1250 displays a list of parcels 1252, where each entry 1254 includes information for a single parcel. Page 1250 may provide a color/symbol code for the entries 1254 in the list 1252, indicating a status of each parcel within the list. Page 1300 displays information related to earnings, which can be separated by week or by courier, for example. Page 1300 may display the information as a list of weekly earnings 1302, where each entry includes information related to a given week such as the number of deliveries completed during the week and the total earnings for the week, for example. Upon clicking on the “Package detail” button 1304, page 1300 displays details of every parcel delivered or handed off during the week.

It should be appreciated from the present disclosure that the methods and systems for parcel delivery in multi-unit dwellings can offer improvements and advantages over existing delivery processes. In particular, the systems and methods allow for having an intermediate agent handle last-meter delivery to addresses normally not accessible by a courier. The intermediate agent can be an individual who is authorized to access secured areas of the multi-unit dwelling, such as a resident with an access key, thereby maintaining the security and privacy in the multi-unit dwelling. Further, the systems and methods can reduce the need for delivery/storing areas where parcels get delivered, thereby freeing space within a multi-unit dwelling, and reducing management problems that can arise for larger multi-unit dwellings.

While the methods and systems have been described in conjunction with the exemplary embodiments described above, many equivalent modifications and variations will be apparent to those skilled in the art when given this disclosure. For example, although the systems and methods have been described in connection with multi-unit dwellings, it is appreciated that this is for exemplary purposes only and that similar systems and methods can apply to delivery parcels to any type of multi-unit building (such as an office building), any building having recipients that are located in a secure area normally not accessible by courier, and/or any building or area where it is logistically complex to delivery parcels to multiple different recipients. The systems and methods can also apply to other situations where it may be advantageous to designate an agent to handle last-meter deliveries, for example to handle deliveries within a neighbourhood, a gated community, or to handle delivery of parcels at a designated carrier pick up point. Accordingly, the exemplary embodiments set forth above are considered to be illustrative and not limiting. The scope of the claims should not be limited by the preferred embodiments set forth in this disclosure but should be given the broadest interpretation consistent with the description as a whole.

1. A method for last-meter parcel delivery comprising:
receiving, at an agent coordinating back-end, parcel delivery information of a parcel to be delivered to a recipient by a courier service;
determining, by the agent coordinating back-end, one or more agents capable of receiving parcels for last-meter delivery to the recipient;
transmitting, by the coordinating back-end, a delivery notification based on the parcel delivery information to one or more agent devices associated with the one or more agents;
receiving, by the coordinating back-end, confirmation from an agent device that the delivery notification is accepted by an agent associated with the agent device;
transmitting to the courier service, by the coordinating back-end, agent information, for re-routing the parcel to the agent;
receiving, by the agent coordinating back-end, a confirmation from the agent device that the parcel is received by the agent; and
receiving, by the agent coordinating back-end, a confirmation from the agent device that last-meter delivery of the parcel to the recipient is performed.

2. The method of claim 1, further comprising steps of:
scanning, with the agent device, parcel information associated with the parcel upon at least one of receiving said parcel by the agent and performing the last-meter delivery of the parcel;
receiving, at the coordinating back-end, status updates from the agent device based on the scanning of the parcel information, for tracking the parcel; and
forwarding, by the coordinating back-end, the status updates to the courier service.

3. The method of claim 1, wherein:
the recipient is associated with a destination address,
agents are each associated with a range of addresses, and
the step of determining the one or more agents comprises comparing the destination address with the range of addresses of each agent and identifying the one or more agents having a respective range of addresses matching the destination address.

4. The method of claim 3, wherein a given range of addresses corresponds to addresses located within a multi-unit dwelling, and wherein determining the one or more agents further comprises verifying that the one or more agents have physical access to the multi-unit dwelling of the destination address.

5. The method of claim 4, wherein the multi-unit dwelling is provided with a management software, and wherein the steps further comprise:
transmitting, to the management software, a confirmation from the agent device that the parcel is received at the multi-unit dwelling by the agent.

6. The method of claim 3, wherein only one agent is associated with a given range of addresses, and wherein the step of transmitting the delivery notification comprises transmitting the delivery notification to an agent device associated with the one agent.

7. The method of claim 3, further comprising steps of:
identifying, by the agent coordinating back-end, a plurality of parcel deliveries for which recipients are located within a given range of addresses; and
grouping the plurality of parcel deliveries into a job delivery notification, wherein the job delivery notification is transmitted to the one or more agent devices.

8. The method of claim 1, further comprising a step of:
transmitting, to a recipient device, an update notification upon the agent receiving the parcel, the update notification indicative that the parcel is ready for pick-up by the recipient.

9. The method of claim 1, further comprising a step of:
transmitting, to a recipient device, an update notification upon the agent receiving the parcel, the update notification indicative that the parcel is out for delivery at a destination address associated with the recipient.

10. The method of claim 1, further comprising, upon unsuccessful last-meter delivery of the parcel to the recipient:
transmitting a request for parcel pick-up to the courier service, the request including a pick-up address; and
receiving, by the agent coordinating back-end, a confirmation that the parcel is picked up by the courier service.

11. A system for last-meter parcel delivery of a parcel to be delivered by a courier service to a recipient, the system comprising:
an agent device associated with an agent and comprising a user interface adapted to interact with the agent, and
an agent coordinating server adapted to communicate with the agent device and courier server associated with the courier service, the agent coordinating server being further adapted to:
receive, from the courier server, parcel delivery information associated with the parcel;
transmit a delivery notification based on the parcel delivery information to the agent device upon determining that the agent is capable of receiving parcels for last-meter delivery to the recipient;
receive confirmation from the agent device that the delivery notification is accepted;
transmit agent information to the courier server for re-routing the parcel to the agent;
receive a confirmation from the agent device that the parcel is received by the agent; and
receive a confirmation from the agent device that last-meter delivery of the parcel to the recipient is performed.

12. The system of claim 11, wherein the user interface is further adapted to enable scanning parcel information associated with the parcel upon at least one of receiving said parcel by the agent and performing the last-meter delivery of the parcel, and wherein the agent coordinating server is further adapted to:
receive status updates from the agent device based on the scanning of the parcel information, for tracking the parcel; and
forward the status updates to the courier server.

13. The system of claim 11, further comprising a plurality of agent devices associated with a plurality of agents, each of the plurality of agents associated with a range of addresses, wherein the agent coordinating server is further adapted to transmit the delivery notification to one or more agent devices associated with one or more agents having a range of addresses matching a destination address associated with the recipient.

14. The system of claim 13, wherein a given range of addresses corresponds to addresses located within a multi-unit dwelling, and wherein the delivery notification is transmitted to the one or more agents having physical access to the multi-unit dwelling.

15. The method of claim 14, wherein the multi-unit dwelling is provided with a management software, and wherein the system is further adapted to:
transmit, to the management software, a confirmation that the parcel is received at the multi-unit dwelling by the agent.

16. The system of claim 13, wherein the agent coordinating server is further adapted to:
identify a plurality of parcel deliveries for which recipients are located within a given range of addresses; and
group the plurality of parcel deliveries into a job delivery notification, the job delivery notification being transmitted as the delivery notification to the one or more agent devices.

17. The system of claim 11, wherein the agent coordinating server is further adapted to:
transmit, to a recipient device associated with a recipient of the parcel, an update notification upon the agent receiving the parcel, the update notification indicative that the parcel is ready for pick-up.

18. The system of claim 11, wherein the agent coordinating server is further adapted to:
transmit, to a recipient device associated with a recipient of the parcel, an update notification upon the agent receiving the parcel, the update notification indicative that the parcel is out for delivery to the recipient.

19. The system of claim 11, wherein the user interface is further adapted to, upon unsuccessful last-meter delivery of the parcel, enable scheduling a request for parcel pick-up to the courier server, the request including a pick-up address, and wherein the agent coordinating server is further adapted to receive a confirmation that the parcel is picked up by the courier service.

20. A method for last-meter parcel delivery to multi-unit dwellings, comprising:
scanning, by a courier, a parcel being loaded on a delivery vehicle for last-mile delivery to a recipient;
determining, based on parcel information retrieved by scanning the parcel, one or more agents eligible to handle last-meter delivery of the parcel in a multi-unit dwelling associated with the recipient;
transmitting a delivery notification to the one or more agents, the delivery notification indicating that the parcel is available for last-meter delivery by an agent;
accepting responsibility for the last-meter delivery of the parcel by an agent of the one or more agents;
rerouting the parcel delivery to the agent;
delivering, by the courier, the parcel to the agent; and
delivering, by the agent, the parcel to the recipient.
